(19) United States
(12) Patent Application Publication
(10) Pub. No.: US 2005/0121974 A1
(43) Pub. Date: Jun. 9, 2005

(54) Method and device for monitoring a brake system

(75) Inventor: Gunther Buschmann, Idstein (DE)

Correspondence Address: RATNERPRESTIA, P O BOX 980, VALLEY FORGE, PA, 19482-0980, US

(73) Assignee: Continental Teves AG & Co. oHG, Frankfurt (DE)

(21) Appl. No.: 10/499,733

(22) PCT Filed: Dec. 18, 2002
(86) PCT No.: PCT/EP02/14479

(30) Foreign Application Priority Data
Dec. 20, 2001 (EP) 101 62 623.1
Nov. 26, 2002 (EP) 102 54 987.7

(51) Int. Cl. B60T 8/88

(52) U.S. Cl. 303/122.09; 303/DIG. 11

(57) ABSTRACT

The present invention relates to a method and a device for monitoring a brake system for motor vehicles equipped with an electronic controlling and regulating unit, as well as a hydraulic pressure accumulator that is used as an auxiliary pressure source and subdivided by a media-separating element into two chambers, the first chamber being filled with a gas and the second chamber being filled with a liquid pressure medium. To conduct a reliable monitoring of the pressure accumulator, the invention provides that the number of the partial strokes of the media-separating element is detected. To this end, brake actuations are weighted and counted according to their duration and intensity. When the sum of the weighting factors reaches a predetermined number, a warning indicates an imminent damage to the media-separating element. This renders it possible to use a less costly and less sensitive media-separating element, which obviates the need for extensive protective measures against mechanical loads.

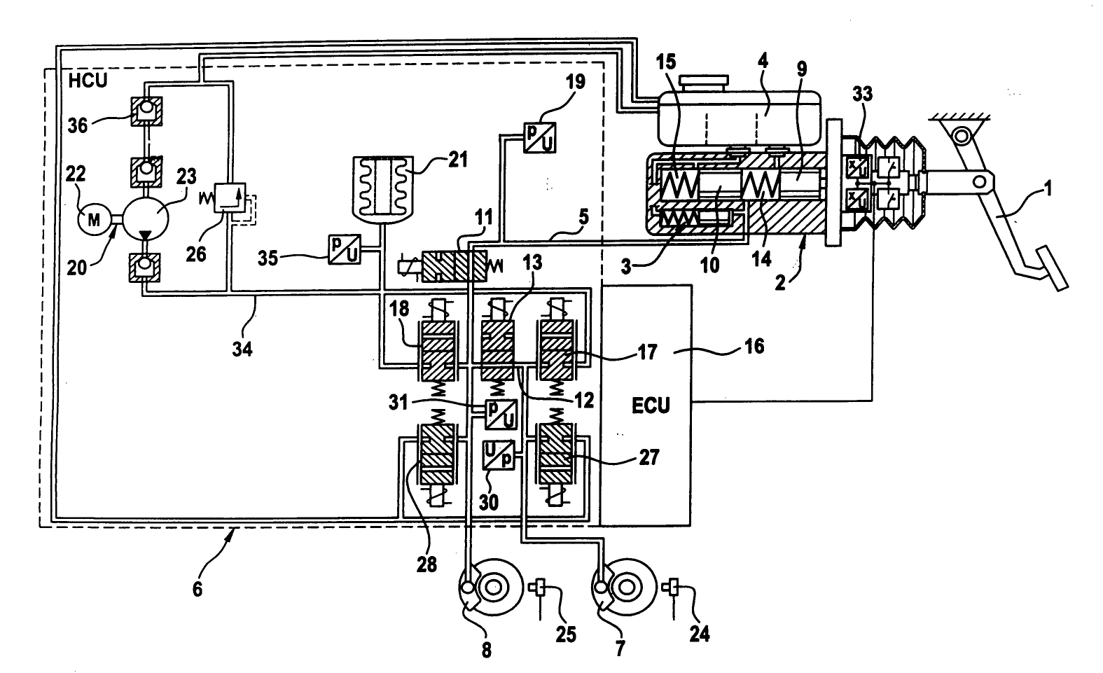

### TECHNICAL FIELD

The present invention generally relates to a method and a device for monitoring a brake system for motor vehicles and more particularly relates to a method and a device for monitoring a brake system for motor vehicles equipped with a hydraulic pressure accumulator.

### BACKGROUND OF THE INVENTION

A brake system of this type is disclosed in international patent application WO 99/41125. An electrohydraulic brake system of the ‘brake-by-wire’ type is concerned including a means for the detection of gases disposed in the system.

The pressure fluid accumulator disclosed in the international patent application WO 00/31420 can be used as an auxiliary pressure source in the system mentioned above. The media-separating element in this pressure accumulator is composed of a metallic bellows. To achieve a sufficient degree of fatigue strength in terms of the full extent of functioning, the bellows is made of a thin-walled material. The result is that it must be prevented by complicated and cost-intensive measures that the bellows will expand excessively in operation, what is considered disadvantageous. Besides, the reduced compression resistance compared to a thick-walled bellows is regarded as a shortcoming.

### BRIEF SUMMARY OF THE INVENTION

In view of the above, an object of the invention is to develop a method for monitoring the media-separating element as regards its material fatigue that is due to operation. Thus, a media-separating element with an increased material strength and, thus, a reduced fatigue strength is desired to be used which is less sensitive to strong expansions and obviates the need for special protective measures regarding mechanical loads.

This object is achieved by the method in that loading and unloading operations of the pressure accumulator are detected and evaluated electronically in order to detect an imminent risk of damage to the media-separating element.

To render the idea of the invention more precise, it is arranged that when evaluating the loading and unloading operations, the maximum pressure values (or locking pressure values) that occur during a braking operation are divided into various classes and that these classes are determined by pressure and/or time values.

Further favorable features of the method of the invention can be taken from the sub claims 4 to 9.

The brake system of the invention for implementing the method described hereinabove is characterized in that the electronic controlling and regulating unit comprises a means detecting the loading and unloading operations of the pressure accumulator and electronically evaluating them in order to detect an imminent risk of damage to the media-separating element.

Further favorable features of the brake system of the invention can be taken from the sub claims 11 to 14.

### BRIEF DESCRIPTION OF THE DRAWINGS

The sole FIGURE shows a schematic view of an electrohydraulic brake system in which the method of the invention can be implemented.

### DETAILED DESCRIPTION OF THE PREFERRED EMBODIMENTS

The brake system of the present invention, only represented in the drawing, is generally comprised of a dual-circuit hydraulic pressure generator or tandem-design master brake cylinder. 2 which is operable by means of a brake pedal 1, a travel simulator 3 cooperating with the tandem master cylinder 2, a pressure fluid reservoir 4 associated with the tandem master cylinder 2, a hydraulic pressure source, a control unit HCU 6 (shown only schematically) which comprises, among others, all components necessary for pressure control operations and to which wheel brakes 7, 8 associated with e.g. the rear axle of the motor vehicle are connected, as well as an electronic controlling and regulating unit 16. Wheel sensors 24, 25 (only represented) are used to determine the rotational speed of the vehicle wheels. The per se known tandem master cylinder 2 comprises pressure chambers 14, 15 separated from each other by two pistons 9, 10, said pressure chambers being connectable both to the pressure fluid reservoir 4 and to the vehicle brakes 7, 8, -, - by way of the HCU 6. The above-mentioned pressure source comprises a motor-and-pump assembly 20 composed of an electric motor 22 and a pump 23 driven by the electric motor 22, a pressure limiting valve 26 connected in parallel to the pump, and a high-pressure accumulator 21 that can be charged by the pump 23 and whose media-separating element is a metallic bellows. A pressure sensor 35 monitors the hydraulic pressure generated by the high-pressure accumulator 21.

As can further be taken from the drawing, the wheel brakes 7, 8 are connected to the first pressure chamber 14 by means of a line 5 in which a separating valve 11 is inserted that is configured as a normally open (NO) two-way/two-position directional control valve and allows closing the first pressure chamber 14. A second hydraulic line 34 connects the pressure side of the pump 23 or the high-pressure accumulator 21 to the inlet ports of two electromagnetically operable, preferably normally closed (NC) two-way/two-position directional control valves or inlet valves 17, 18 of analog control which are connected upstream of the wheel brakes 7 and 8. Another pair of likewise electromagnetically operable, preferably normally closed (NC) two-way/two-position directional control valves or outlet valves 27, 28 of analog control allows a connection of the wheel brake 7, 8 to the pressure fluid reservoir 4, while an electromagnetically operable, preferably normally open (NO) pressure-compensating valve 13 allows controlling the pressures introduced into the wheel brakes 7, 8 on each individual wheel.

Further, pressure sensors 30, 31 are associated with the wheel brakes 7, 8, serving to determine the hydraulic pressure that prevails in the wheel brakes 7, 8. The above-mentioned electronic controlling and regulating unit ECU 16 to which are sent the output signals of the pressure sensors 19, 30, 31, 35, of the wheel speed sensors 24, 25 and of a preferably redundantly designed brake-request acquisition device 33 associated with the master brake cylinder 2, is used to actuate the motor-and-pump assembly 20 and the above-mentioned valves 11, 13, 17, 18, 27, 28.

Among others, the output signals of the pressure sensors 30, 31 are sent to the electronic controlling and regulating unit ECU 16 of the brake system described hereinabove, whose operation is known to the one skilled in the art. In addition, it is identified in the ECU 16 by evaluation of the output signals of the wheel sensors 24, 25 when an anti-lock control operation (ABS control) takes place. In this case, the pressure accumulator 21 is partly emptied several times, while the pressure accumulator 21 is partly emptied only one time in the normal braking mode. The partial evacuation of the pressure accumulator 21 and the pressure to be adjusted in the brake system depend on one another. It is therefore possible during pressure fluid removal to determine from the pressure being adjusted the degree of the evacuation and, thus, the magnitude of the stroke, which the bellows performs during pressure fluid removal. Each loading and unloading operation is allocated to a time-responsive and/or pressure-responsive class and weighted with defined factors by means of an algorithm stored in the ECU 16. Thus, a weighting factor corresponding to the numerical value 10, for example, is associated with a complete unloading. An ABS control operation which lasts longer than 500 msec and whose locking pressure value is higher than 80 bar is weighted with a weighting factor that corresponds e.g. to the numerical value 6, and a control with a locking pressure value ranging between 30 bar and 80 bar is weighted with a weighting factor of e.g. 5. Likewise, an ABS control operation lasting at least 500 msec and a locking pressure value lower than 30 bar is weighted with a weighting factor that corresponds e.g. to the numerical value 4.

In the normal braking mode, the required maximum pressure value in the brake system is used as a characteristic quantity for the stroke. A normal braking operation with a maximum pressure value of more than 80 bar is weighted with a weighting factor that corresponds e.g. to the numerical value 3, and consequently normal braking operations with maximum pressure values between 30 bar and 80 bar are weighted with a weighting factor of e.g. 2 and normal braking operations with maximum pressure values of less than 30 bar are weighted with a weighting factor of e.g. 1. These weighting factors are stored in an electronic counting device contained in the ECU 16 and added. When the sum of these weighting factors or the count of the counter is higher than a predetermined number, the bellows must be replaced due to the material fatigue that occurred. The necessity of replacement is indicated to the driver by a warning signal (not shown), for example by a signal lamp flashing up.

It is this way possible to monitor the bellows with respect to its material fatigue that is due to operation. Thus, a less sensitive bellows with a thicker material strength can be used that offers advantages from a financial point of view and under manufacturing technology aspects.

1-14. (canceled)

15. Method of monitoring a brake system for motor vehicles equipped with an electronic controlling and regulating unit, as well as a hydraulic pressure accumulator that is used as an auxiliary pressure source and subdivided by a media-separating element into two chambers, the first chamber being filled with a gas and the second chamber being filled with a liquid pressure medium, wherein the loading and unloading operations of the pressure accumulator are detected and evaluated electronically in order to detect an imminent risk of damage to the media-separating element.

16. Method as claimed in claim 15, wherein when evaluating the loading and unloading operations, the maximum pressure values occurring during a braking operation are divided into various classes.

17. Method as claimed in claim 15, wherein the classes are determined by pressure values and/or time values.

18. Method as claimed in claim 16, wherein one class corresponds to the complete unloading of the pressure accumulator.

19. Method as claimed in claim 16, wherein further classes are associated with a continuing anti-lock control operation (ABS control) with different locking pressure values.

20. Method as claimed in claim 16, wherein the ABS control preferably lasts at least 500 msec.

21. Method as claimed in claim 19, wherein further classes are associated with normal braking operations of different intensities.

22. Method as claimed in claim 16, wherein weighted factors are associated with the classes in terms of any imminent damage to the media-separating element.

23. Method as claimed in claim 22, wherein an alarm signal is generated when the sum of the weighting factors exceeds a predetermined numerical value.

24. Brake system for motor vehicles equipped with an electronic controlling and regulating unit, as well as a hydraulic pressure accumulator that is used as an auxiliary pressure source and subdivided by a media-separating element into two chambers, the first chamber being filled with a gas and the second chamber being filled with a liquid pressure medium, wherein the electronic controlling and regulating unit comprises a means detecting the loading and unloading operations of the pressure accumulator and electronically evaluating them in order to detect an imminent risk of damage to the media-separating element.

25. Brake system as claimed in claim 24, wherein the electronic controlling and regulating unit comprises further electronic means arranging a classification of the maximum pressure values that occur in a braking operation during the evaluation of the loading and unloading operations.

26. Brake system as claimed in claim 24, wherein a counting device is provided summing up the weighting factors.

27. Brake system as claimed in claim 26, wherein a means is provided triggering an alarm signal when the count of the counter exceeds a predetermined numerical value.

28. Brake system as claimed in claim 24, wherein the media-separating element is composed of a metallic bellows.
